(19) United States
(12) Patent Application Publication
(10) Pub. No.: US 2020/0008397 A1
(43) Pub. Date: Jan. 9, 2020

(54) MULTI-MATERIAL PET TOY AND METHOD OF MAKING MULTI-MATERIAL PET TOY

(71) Applicant: Willinger Development LLC, Tenafly, NJ (US)

(72) Inventor: Jonathan WILLINGER, Tenafly, NJ (US)

(73) Assignee: Willinger Development LLC, Tenafly, NJ (US)

(21) Appl. No.: 16/026,505

(22) Filed: Jul. 3, 2018

(51) Int. Cl. A01K 15/02

(52) U.S. Cl. CPC A01K 15/025

(57) ABSTRACT

A multi-material pet toy includes a first body having a first density. A second body has a second density, the second density being less than the first density. The second body is partially received in an inner space of the first body. The first body includes a first opening. The second body includes an intermediate portion, the intermediate portion having a first segment disposed in the inner space of the first body and a second segment disposed outside of the first body. The second segment includes a knot bearing against the first opening.

### BACKGROUND OF THE INVENTION

### 1. Field of the Invention

The invention relates to one or more pet toys having at least two different materials and a method of making the pet toys. More particularly, the invention relates to a pet toy having a molded body and a plush body joined together.

### 2. Discussion of the Related Art

Pets such as dogs are naturally curious and require one or more pet toys to maintain mental stimulation. Typically, pet toys, especially for dogs, are made of single material—a molded material or a plush material.

Each type of toy finds great consumer acceptance by pet owners as well as interest by the pet. A molded pet toy can be produced economically, is generally durable, and can be produced in great varieties. However, due to the same mouth feel, pets eventually tire of playing with the toy.

A plush toy has the disadvantage of not being as durable as a molded pet toy and costing more in production, but has a mouth feel that is pleasant to pets, especially to dogs, and keeps the pet in engaged with the toy longer.

Thus, what is need is a pet toy that is durable, that keeps the pet engaged with the toy, and is economical to produce.

### SUMMARY OF THE INVENTION

These and other needs are met by a pet toy of the present invention.

A multi-material pet toy includes a first body having a first density. A second body has a second density, the second density being less than the first density. The second body is partially received in an inner space of the first body. The first body includes a first opening. The second body includes an intermediate portion, the intermediate portion having a first segment disposed in the inner space of the first body and a second segment disposed outside of the first body. The second segment includes a knot bearing against the first opening.

### BRIEF DESCRIPTION OF THE INVENTION

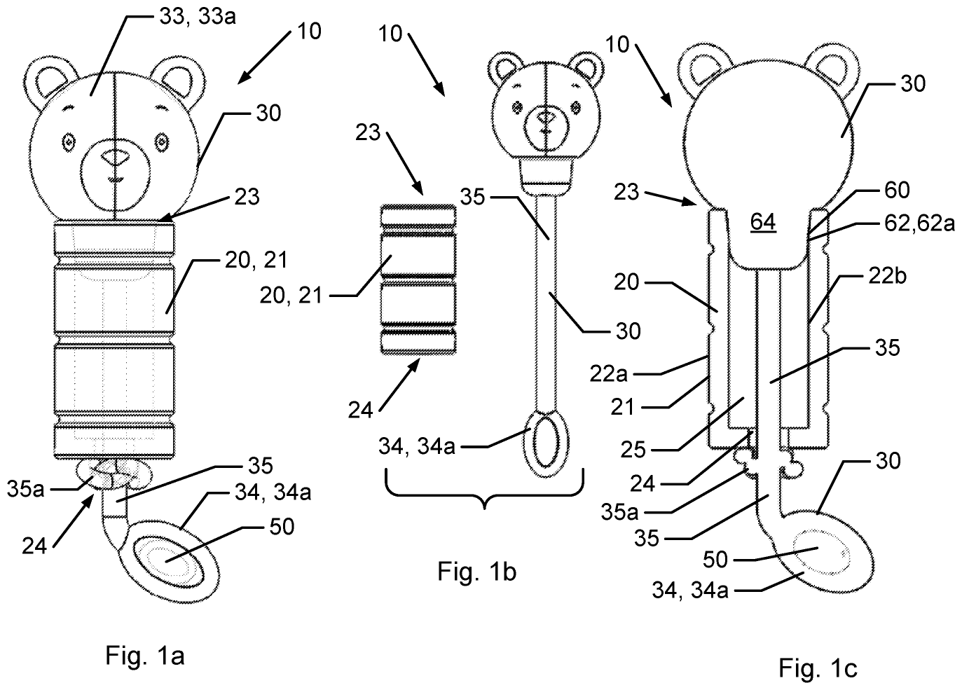

FIGS. 1a, 1b, and 1c are schematic views of a multi-material pet toy in accordance with one or more embodiments of the present invention.

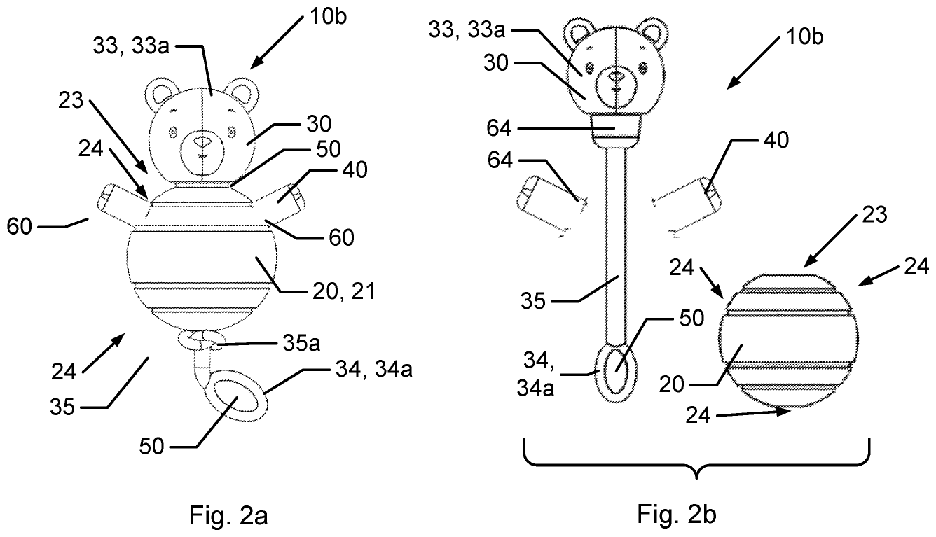

FIGS. 2a and 2b are schematic views of a multi-material pet toy in accordance with one or more embodiments of the present invention.

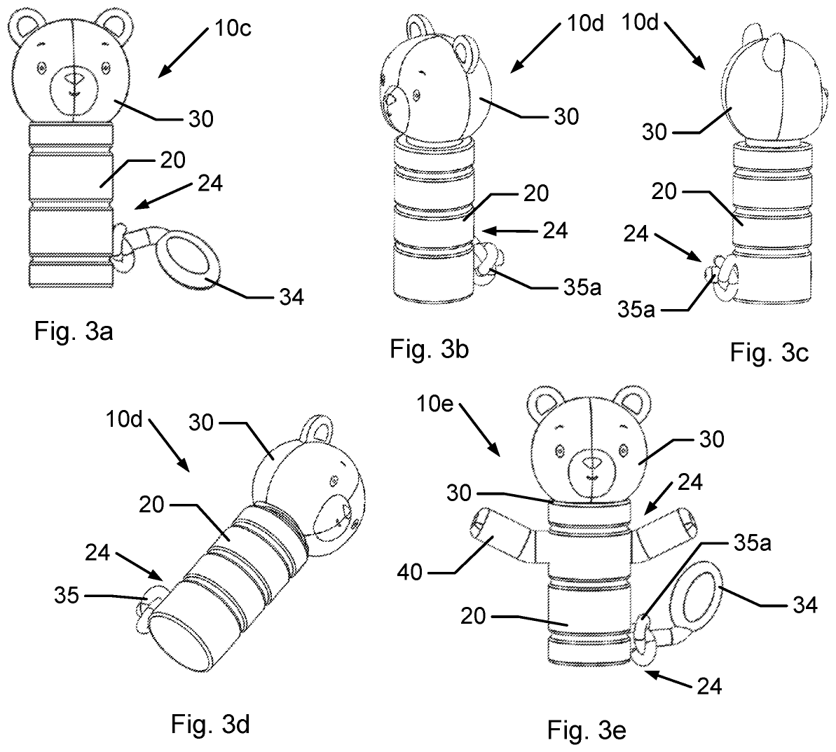

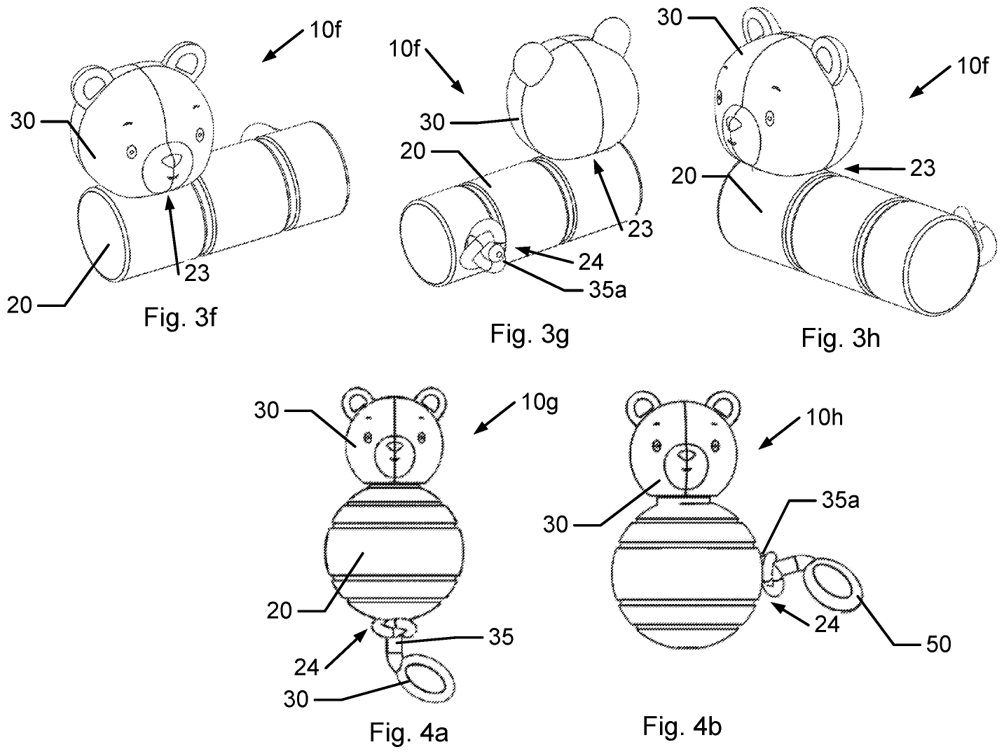

FIGS. 3a-3h are schematic views of one or more multi-material pet toys in accordance with one or more embodiments of the present invention.

FIGS. 4a and 4b are schematic views of one or more multi-material pet toys in accordance with one or more embodiments of the present invention.

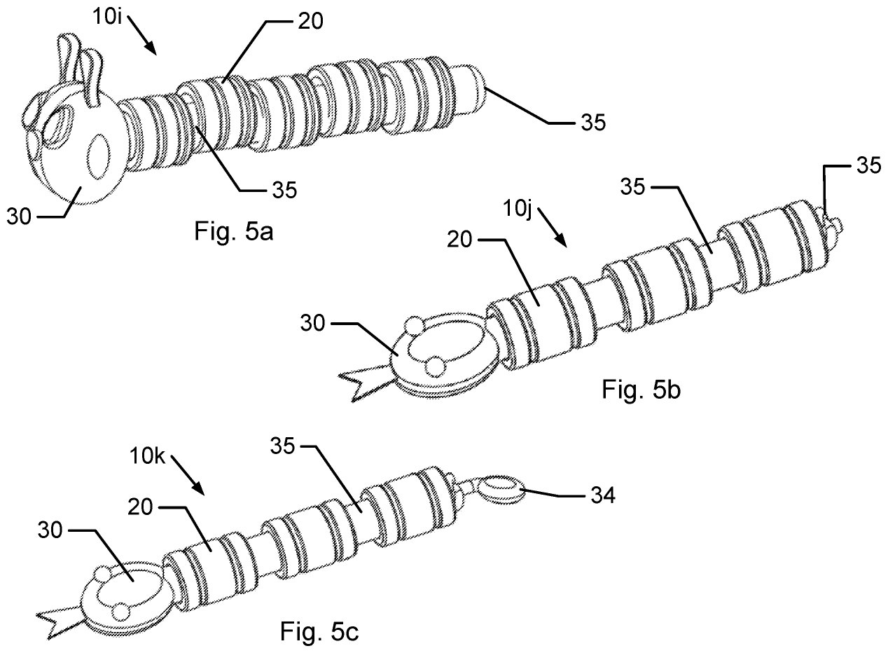

FIGS. 5a-5c are schematic views of one or more multi-material pet toys in accordance with one or more embodiments of the present invention.

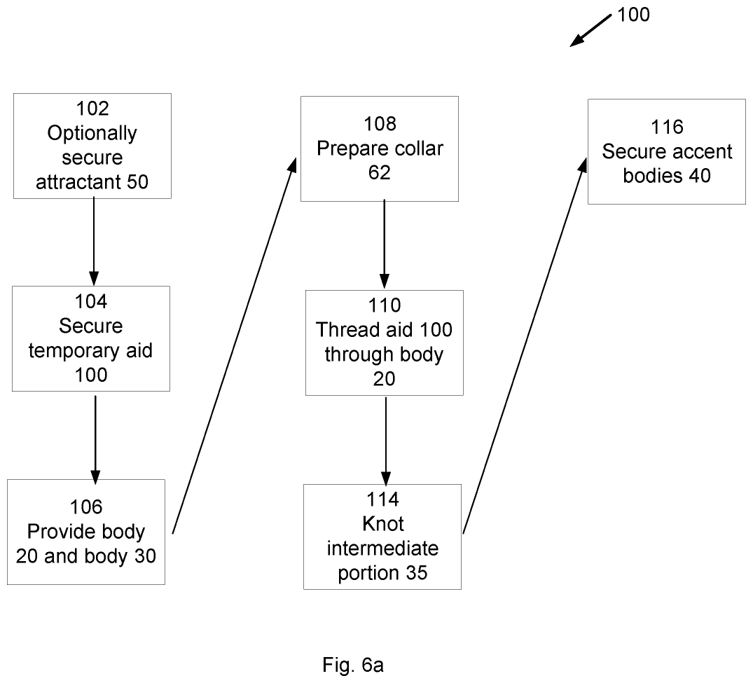

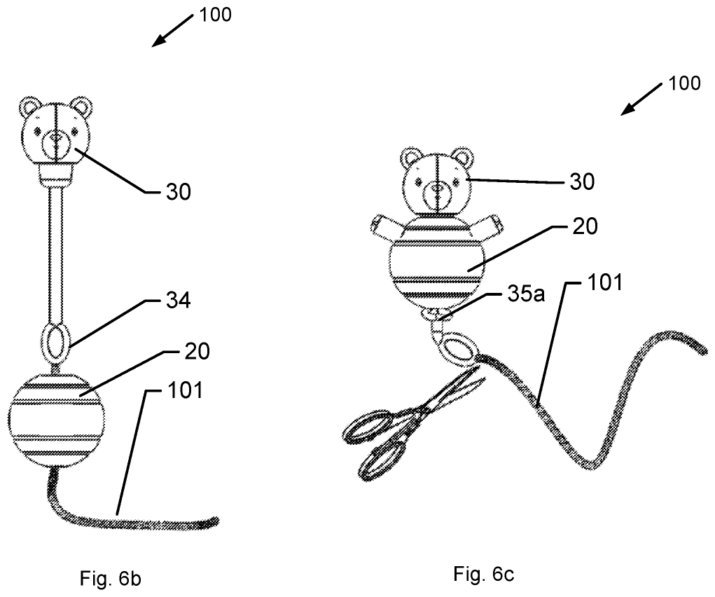

FIG. 6a is a flow diagram of an assembly method of a multi-material in accordance with one or more embodiments of the present invention.

FIGS. 6b and 6c are schematic views of an assembly method of multi-material pet toy in accordance with one or more embodiments of the present invention.

### DETAILED DESCRIPTION OF THE INVENTION

The following detailed description is of the best mode or modes of the invention presently contemplated. Such description is not intended to be understood in a limiting sense, but to be an example of the invention presented solely for illustration thereof, and by reference to which in connection with the following description and the accompanying drawings one skilled in the art may be advised of the advantages and construction of the invention. In the various views of the drawings, like reference characters designate like or similar parts.

Definitions

All technical and scientific terms shall have the same meaning as commonly understood by one of ordinary skill in the art. Nonetheless, the following terms defined below aid in the understanding of the disclosure. The definitions apply to all parts of speech of the term regardless whether the term is defined explicitly as such.

Accordingly, the meaning of specific terms or words used in the specification and the claims should not be limited to the literal or commonly employed sense, but should be construed in accordance with the spirit and scope of the disclosure. The definitions of these terms, therefore, may be determined based on the contents throughout the specification. Where not defined, the meaning of all terms will be clear from the context of the description.

Like numbers refer to like elements throughout, and explanations that duplicate one another are omitted.

“A” and “an” preceding an element or component are intended to be nonrestrictive regarding the number of instances (i.e. occurrences) of the element or component. Therefore, “a” or “an” should be read to include one or at least one, and the singular word form of the element or component also includes the plural unless the number is obviously meant to be singular.

“About,” “approximately,” or “substantially similar” refer to one or more industry-accepted tolerances for the corresponding term and/or relativity between elements. Where such industry-accepted tolerances for the corresponding term are unknown, difficult to determine, inconsistent, or subject to experimentation, “about,” “approximately,” or “substantially similar” refer to a 10% variation from the nominal value. Even if not explicitly stated, it is understood that a variation is always included in a given value, whether or not the variation is specifically referenced. In accordance with one or more embodiments of the present invention, “about,” “approximately,” or “substantially similar” mean within 5% of the reported numerical value. In accordance with one or more embodiments of the present invention, “about,” “approximately,” or “substantially similar” mean within 10, 9, 8, 7, 6, 5, 4, 3, 2, or 1% of the reported numerical value.

“Comprises,” “comprising,” “includes,” “including,” “has,” “having,” “contains,” or “containing,” or any other variation thereof are used to describe and claim a non-exclusive inclusion such that a composition, a mixture, process, method, article, or apparatus that comprises a list of elements is not necessarily limited to only those elements but can include other elements not expressly listed or inherent to such composition, mixture, process, method, article, or apparatus. “Comprises,” “comprising,” “includes,” “including,” “has,” “having,” “contains,” or “containing,” or any other variation thereof may also be understood to mean “including, but not limited to.”

“Connector,” “fastener,” or “fastening device” shall in the singular and plural refer to any device used for mechanically joining two or more parts, components, or the like together for its intended purpose whether temporary or permanent, including a screw, nail, anchors, clamp, cotter pin, retainer, clip, or any other device known or yet to be developed. “Connector,” “fastener,” or “fastening device” shall in the singular and plural refer to an adhesive, cement, glue, or the like. Where a specific embodiment of a “connector,” “fastener,” or “fastening device” is disclosed it shall be understood to be the preferred embodiment of a “connector,” “fastener,” or “fastening device” for reasons of economy, structural integrity, longevity and/or ease of installation.

“Component” shall in the singular and plural refer to one or more parts, elements, pieces, or other items related to a portion of the present invention.

“Invention” or “present invention” are non-limiting terms and not intended to refer to any single aspect of the particular invention but encompass all possible aspects as described in the specification and the claims.

“Mounted,” “mounted in,” or “integrated” shall mean that a first element is directly secured to or in a second element or have intervening elements be present between the first and second element. “Directly mounted” or “directly mounted in” shall mean that no intervening element is present between the first and second element and that the first element is in contact with the second element.

“On,” “over,” “disposed on,” “disposed against,” and/or “disposed over,” shall mean that a first element can be directly located on a second element or have intervening elements be present between the first and second element. “Directly on,” “directly over,” “directly against,” directly disposed against,” “directly disposed on,” and/or “directly disposed over” shall mean that no intervening element is present between the first and second element and that the first element is in contact with the second element.

“One embodiment,” “an embodiment,” “exemplary embodiment,” or variations thereof means that a particular feature, structure, or characteristic described in connection with the embodiment is included in at least one embodiment of the disclosure. The appearances of such phrases in various places in the specification are not necessarily all referring to the same embodiment. Further, when a particular feature, structure, or characteristic is described in connection with any embodiment, it is submitted that it is within the purview of one skilled in the art to affect such feature, structure, or characteristic in connection with others of the embodiments.

“Suitable” or “suitably” in this application refers to a size and/or shape that maintains the structural integrity of the invention and/or permits the intended use of the invention by its intended user in a normal or advantageous manner.

“User” in the singular and the plural refers to a person, entity, and/or other group uses one or more aspects of the present invention.

Construction and Material Selection

FIGS. 1a, 1b, and 1c are schematic views of a multi-material pet toy in accordance with one or more embodiments of the present invention. FIGS. 2a and 2b are schematic views of a multi-material pet toy in accordance with one or more embodiments of the present invention.

A multi-material pet toy 10a, 10b is intended for a dog or other animal prone to biting or chewing behavior, individually or collectively “a canine.” Multi-material pet toy 10a, 10b includes a first body 20 comprising a main body material having a first density, a second body 30 having a main body material having a second density that is less dense than first density 21, and one or more accent bodies 40 as shown in FIGS. 2a and 2b, but applicable to FIGS. 1a, 1b, and 1c. Second body 30 is at least partially received in first body 20 and one or more accent bodies 40 are at least partially received in first body 20.

In accordance with one or more embodiments of the present invention, first body 20 may be molded and is made of one or more plastic types, such as a thermoplastic elastomer; rubber types, such as natural rubber. In contrast, the main body material of second body 30 may be made of one or a combination of less dense materials, such as foam or plush material, but may also include a rope material, such as hemp or jute. A plush material, generally, comprises a fabric cover of a soft yet durable material and a filing or stuffing material of cotton or artificial material.

Pet toys having a molded material or plush material find each great consumer acceptance by canine owners as well as interest by the canine. The contrast of the two materials in one toy finds even greater consumer acceptance than each material individually.

Body 20 may have any suitable size and/or suitable shape. “Suitable” or “suitably” in this context refers to a size and/or shape that permit easy biting, grasping, and/or playing by a canine with its mouth, but it also refers to a size and/or shape that permits easy handling and/or throwing by the canine's owner. This, preferably, comprises a cylindrical shape, a truncated cone, a suitably sized ball, or stylized representation of a geometric object or anthropomorphic representation of an animal.

A texture 21 is preferably applied to an exterior surface 22a of body 20 or is an integral with body 20. An interior surface 22b is opposite exterior surface 22a. Body 20 comprises a primary opening 23, one or more secondary openings 24, and an interior space 25.

Body 30 is partially received in interior space 25 and extends through primary opening 23 and through at least one or all of the secondary openings 24. Specifically, body 30 comprises a primary portion 33 having a discernable shape 33a, that, preferably, is an anthropomorphic representation of an animal or a portion of an animal. For example, discernable shape 33a is the head of a bear having a representation of mammalian facial features and includes among other facial features eyes, ear, nose, mouth, eyebrows. A portion of primary portion 33 is received in body 20 by being passed wholly or partially through primary opening 23 and mounted using a collar construction 50.

In accordance with one or more embodiments of the present invention, the periphery at least one opening or all openings of body 20 is preferably chamfered to prevent injury to the canine.

In accordance with one or more embodiments of the present invention, at least one opening or all openings of body 20 is preferably reinforced on the inside and/or outside of body 20 at a periphery of the opening to prevent tearing of the periphery of the respective opening. Reinforcing may be accomplished by having a rounded, protruding lip on the marginal area surrounding the opening on exterior surface 22a and/or interior surface 22b.

Body 30 further comprises one or more secondary portions 34. Each secondary portion 34, preferably, comprises a discernable shape 34a that is an anthropomorphic representation of an animal or a portion of an animal. For example, discernable shape 34a is an animal tail and, preferably, the discernable shape 33a and discernable shape 34a are anthropomorphic representation of the same animal. Secondary portions 34 are disposed at least partially in or entirely outside interior space 25.

Body 30 further includes an intermediate member 35 comprising any suitable shape, but preferably is a rope-shape. Intermediate member 35 is connected to the primary portion 33 and at least one secondary portion 34. Body 35 comprises a knot 35a that is larger than secondary opening 24 and knot 35a bearing against a portion of body 20 that is peripheral to secondary opening 24.

In accordance with one or more embodiments of the present invention, a secondary portion 34 that is received partially through primary opening 23 comprises a collar construction 50 as taught herein.

The one or more accent bodies 40 may be made of one or a combination of materials that are less dense than the materials comprising body 20. Such less dense materials may be foam or plush material, but may also include a rope material, such as hemp or jute. A plush material, generally, comprises a fabric cover of a soft yet durable material and a filing or stuffing material of cotton or artificial material. Accent bodies 40 are received partially through secondary openings 24 and comprise a collar construction 50 as taught herein.

In accordance with one or more embodiments of the present invention, accent bodies 40 are joined to intermediate portion 35 and in assembly pulled through secondary openings 24 so that the accent bodies extend away from body 20.

One or more attractants 50 may be disposed anywhere in body 20 and/or in or attached to body 30. In accordance with one or more embodiments of the present invention, attractant 50 may be one or more sound makers disposed in the primary portion 33 or one or more secondary portions 34. The sound maker may be a bell, a rattle, a pillow squeaker, an accordion-style squeaker, and/or a reed-based sound maker. For example, a sound maker is pillow squeaker that is disposed in primary portion 33 of body 30 or is a bell disposed in an interior space 25 of body 20.

Attractant 50 may also be a scent source disposed in the primary portion 33 or one or more secondary portions 34 or more, of in an interior space 25 of body 20.

A collar construction 60 comprises a receiver portion 62 on body 20 and a dimensionally reduced portion 64 of body 30 to increase retention in a respective opening, i.e. primary opening 23 or secondary opening 24, of body 20. For clarity the opening into which dimensionally reduced portion 64 is received is the “receiving opening.”

Receiver portion 62 comprises a band of material, herein a collar 62, on inner surface 22b, preferably, immediately adjacent or proximal to receiving opening. To increase retention of reduced portion 64 in the receiving opening, collar 62 comprises a texturing 62a such a ribbing perpendicular, diagonal, and/or parallel to a plane of the receiving opening or a texturing 62 comprising irregular elements, dotting.

Reduced portion 64 is preferably sized to be larger than an inner diameter than a nominal diameter or nominal area of collar 62. The nominal diameter or nominal area is determined by disregarding texturing 62a. Preferably, reduced portion 64 is between 5-10% larger than a nominal diameter or nominal area of collar 62 or, in another embodiment 10-20% larger than a nominal diameter or nominal area of collar 62.

In accordance with one or more embodiments of the present invention, texturing 62a comprises or consists of a tacky material, a tacky rubber, and/or a high-friction non-rubber material that easily adheres to foam or plush material of body 30.

In accordance with one or more embodiments of the present invention, instead of texturing 62a an adhesive including glue is placed proximal on interior surface proximal to the receiving opening.

FIGS. 3a-3h are schematic views of one or more multi-material pet toys in accordance with one or more embodiments of the present invention. In FIG. 3a, a multi-material pet toy 10c is constructed similar to pet toy 10a and comprises a cylindrical body 20 but rather than having a secondary opening 24 at a distal end of body 20, secondary opening 24 is disposed on a side of body 20.

In FIGS. 3b-3d, a multi-material pet toy 10d is constructed similar to pet toy 10a and comprises a cylindrical body 20 but rather than having a secondary opening 24 at a distal end of body 20, secondary opening 24 is disposed on a side of body 20. Moreover, rather than having a secondary portion 34, an intermediate portion 35 is an end portion to body 30.

In FIG. 3e, a multi-material pet toy 10e is constructed similar to pet toy 10a and comprises a cylindrical body 20 but rather than having a secondary opening 24 at a distal end of body 20, secondary opening 24 is disposed on a side of body 20. Moreover, a pair of accent bodies 40 are provided to indicate arms and are received in receiving openings, i.e. secondary openings 24.

In FIGS. 3f-3h, a multi-material pet toy 10f is constructed similar to pet toy 10a and comprises a cylindrical body 20 but rather than having a primary opening 23 at a proximal end of body 20 and a secondary opening 24 at a distal end of body 20, primary opening 23 and secondary opening 24 is disposed on a side of body 20. Moreover, rather than having a secondary portion 34, an intermediate portion 35 is an end portion to body 30. Specifically, knot 35a is an end portion to body 30.

FIGS. 4a and 4b are schematic views of one or more multi-material pet toys in accordance with one or more embodiments of the present invention. In FIG. 4a, a multi-material pet toy 10g is constructed similar to pet toy 10b and comprises a spherical body 20 but does not include accessory bodies 40. In FIG. 4b a multi-material pet toy 10h is constructed similar to pet toy 10b and comprises a spherical body 20 but rather than having a secondary opening 24 at a distal end of body 20, secondary opening 24 is disposed on a side of body 20.

FIGS. 5a-5c are schematic views of one or more multi-material pet toys in accordance with one or more embodiments of the present invention. In FIGS. 5a and 5c, a multi-material pet toy 10i, 10j is constructed similar to pet toy 10a and comprises a plurality of cylindrical bodies 20 slidable on intermediate portion 35. Moreover, rather than having a secondary portion 34, an intermediate portion 35 is an end portion to body 30. Specifically, knot 35a is an end portion to body 30.

In FIG. 5c, a multi-material pet toy 10i, 10j is constructed similar to pet toy 10a and comprises a plurality of cylindrical bodies 20 slidable on intermediate portion 35. Moreover, a secondary portion 34 is an end portion to body 30. Specifically, knot 35a is an end portion to body 30

Each of the multi-material pet toy may incorporate, delete, and/or substitute one or more features of one or more of the other multi-material pet toys and may be made as taught with respect to any other toy herein. Details disclosed with one embodiment may be readily used with another.

Assembly Method

FIG. 6a is a flow diagram of an assembly method of a multi-material in accordance with one or more embodiments of the present invention. FIGS. 6b and 6c are schematic views of an assembly method of multi-material pet toy in accordance with one or more embodiments of the present invention. An assembly method 100 of a multi-material pet toy 10 performed by an assembler includes the following steps, which are preferably, but not necessarily performed in the sequence listed.

In a step 102, optionally, an attractant 50 is securely provided inside one of the main body portion 33 or secondary body portion 34 of body 30.

In a step 104, a temporary aid 101 in the form of a rope is secured via a first end 101a to a distal portion body 30, specifically to a secondary body portion 34.

In a step 106, body 20 and body 30 are provided to an assembler. One or more bodies 40 may be optional depending on the design of pet toy 10 and may not be provided, however, in the present description it is assumed that one or more bodies 40 are used.

In a step 108, collar 62 is prepared by cleaning it or applying an adhesive.

In a step 110, temporary aid 101 is threaded into inner space 25 via primary opening 23 and exit inner space 25 via secondary opening 24 causing aid 101 to pass through body 20. Aid 101 is preferably sufficiently long to pass a second end 101b through body 20 without passing a first end 101a though body 20.

In a step 112, using aid 101, a portion of body 30 is pulled so that dimensionally reduced portion 54 of primary portion 33 is received in a respective opening and secondary portion 34 is passed through secondary opening 24.

In a step 114, the intermediate portion 35 is knotted so that a slight tension exists in the intermediate portion 35 that is disposed in body 20

In a step 116, accent bodies 40 are forced into receiving openings so that dimensionally reduced portion 54 is received in a respective opening and accent body 40 is substantially exterior of body 20. This completes multi-material pet toy 10a-10k.

While the invention has been described in conjunction with specific embodiments, it is to be understood that many alternatives, modifications, and variations will be apparent to those skilled in the art in light of the foregoing description.

What is claimed is:

1. A multi-material pet toy comprising:
a first body comprising a first density;
a second body comprising a second density, the second density being less than the first density;
the second body being partially received in an inner space of the first body;
the first body comprising a first opening;
the second body comprising an intermediate portion, the intermediate portion having a first segment disposed in the inner space of the first body and a second segment disposed outside of the first body;
the second segment comprising a knot bearing against the first opening.

2. The multi-material pet toy of claim 1,
wherein the first body comprises a second opening:
wherein the second body comprises a primary portion partially received in the second opening.

3. The multi-material pet toy of claim 1, wherein the first body comprises a molded body.

4. The multi-material pet toy of claim 3, wherein the second body comprises a plus material.

5. The multi-material pet toy of claim 4, wherein the intermediate portion is a rope.

6. The multi-material pet toy of claim 1, wherein the first opening is at a distal end of first body.

7. The multi-material pet toy of claim 2, wherein the first opening is in a distal end of the first body and the second opening is in a proximal end of the first body.

8. The multi-material pet toy of claim 2, wherein the first opening is in a side of the first body and the second opening is in a proximal end of the first body.

9. The multi-material pet toy of claim 2, wherein the first opening is in a side of the first body and the second opening is in the side of the first body.
